(19) United States
(12) Patent Application Publication
(10) Pub. No.: US 2025/0086456 A1
(43) Pub. Date: Mar. 13, 2025

(54) USING A TRAINED AI MODEL IN A PROCESS FOR USER MANAGEMENT OF FIELD DEVICES IN AUTOMATION TECHNOLOGY

(71) Applicant: Endress+Hauser Conducta GmbH+Co. KG, Gerlingen (DE)

(72) Inventors: Thomas Alber, Stuttgart (DE); Axel Pöschmann, Basel (CH)

(21) Appl. No.: 18/830,742

(22) Filed: Sep. 11, 2024

(30) Foreign Application Priority Data
Sep. 11, 2023 (DE) 10 2023 124 379.9

(51) Int. Cl. G06N 3/08

(52) U.S. Cl. CPC G06N 3/08

(57) ABSTRACT

The present disclosure comprises a computer-implemented process for training an AI model, comprising providing training data, wherein the training data comprise input data and output data. The input data comprise identification and/or function data of a plurality of field devices, and the output data each comprise a result associated with the field devices as to whether or not logging into a user management system was permitted. The training data is fed to the AI model. The process also includes training the AI model using machine learning based upon the training data to identify one or more relationships between the identification and/or function data and the associated results, and using the trained AI model in a process for user management of field devices in automation technology.

### CROSS-REFERENCE TO RELATED APPLICATION

The present application is related to and claims the priority benefit of German Patent Application No. 10 2023 124 379.9, filed on Sep. 11, 2023, the entire contents of which are incorporated herein by reference.

### TECHNICAL FIELD

The present disclosure relates to a computer-implemented process for training an AI model. Furthermore, the present disclosure relates to the use of an AI model, which has been trained by means of the process according to the present disclosure, in a process for user management of field devices in automation technology. Furthermore, the present disclosure comprises a computer-readable medium that encodes instructions that define an AI model that has been trained using the process according to the present disclosure. The present disclosure furthermore comprises a computer system comprising a computer-readable medium according to the present disclosure.

### BACKGROUND

Field devices that are used in industrial plants are already known from the prior art. Field devices are often used in process automation engineering, as well as in manufacturing automation engineering. In principle, all devices which are process-oriented and which supply or process process-relevant information are referred to as field devices. Field devices are thus used for detecting and/or influencing process variables. Measuring devices, or sensors, are used for detecting process variables. These are used, for example, for pressure and temperature measurement, conductivity measurement, flow measurement, pH measurement, fill-level measurement, etc., and detect the corresponding process variables of pressure, temperature, conductivity, pH value, fill level, flow, etc. Actuators are used for influencing process variables. These are, for example, pumps or valves that can influence the flow of a fluid in a pipe or the fill level in a tank. In addition to the aforementioned measuring devices and actuators, field devices are also understood to include remote I/O's, radio adapters, or, generally, devices that are arranged at the field level.

A multitude of such field devices are produced and marketed by the Endress+Hauser group.

In modern industrial plants, field devices are usually connected to superordinate units via communications networks such as fieldbuses (Profibus®, Foundation® Fieldbus, HART®, etc.). Usually, the superordinate units are control systems (DCS) or control units, such as an SPC (stored program control). The superordinate units are used for, among other things, process control, process visualization, and process monitoring, as well as commissioning of the field devices. The measured values recorded by the field devices, especially by sensors, are transmitted via the respective bus system to one (or in some cases several) superordinate unit(s). In addition, data transmission from the superordinate unit via the bus system to the field devices is also required, especially for configuration and parameterization of field devices and for controlling actuators.

Mobile control units can also be used to operate field devices that have implemented an FDT frame application. For example, there are control units that are connected to the fieldbus network. However, the control unit can also communicate with the field devices via a wireless communications connection, in particular based upon a Bluetooth standard. The applicant produces and sells devices which, as so-called Bluetooth gateways, allow the control units to be coupled to the field devices. The field device is connected to a Bluetooth gateway via a wired connection, in particular using the HART communications standard or a proprietary standard (for example, CDI, by means of which the applicant's field devices can be addressed). Alternatively, the field devices themselves have their own Bluetooth interfaces.

If a mobile device, such as a smartphone or tablet, is used as a control unit for wireless communication with the field devices, application programs, so-called apps, are available which make the operating functions for the field device available to the mobile device.

In industrial environments, most of the installed field devices have no or only very basic protection against unauthorized access. In these field devices, all device parameters can usually be accessed directly or, for example, after entering an unlock code. As a result of the Federal Security Act in Germany, more and more field devices are coming onto the market that have individual user accounts and role-based authorization. For access via a user interface or machine interface, an, in a certain sense “permanent,” authorization is required, which is usually granted by prior authentication. The authorization must be chosen in such a way that the access user has (permanently) all the authorizations they need to carry out their tasks. Standards such as IEC 62443-4-2 require that a “component” must have a means of authenticating users, and that there shall be role-based granting of permissions (authorization).

Due to the resulting immense administrative effort for the login data of the field devices, technologies for central user administration are emerging, as has been common practice in the IT sector for years with regard to IT devices (for example, printers, workstations, etc.). An example of such a concept is disclosed in DE 10 2018 1026 08 A1, in which a transport medium is provided to which user data are transferred from a user database, wherein, after checking the user data, access to the field device is granted.

There are also ideas for limiting the access permissions required by people to a minimum. DE 102019131860 A1, for example, discloses providing a digital order ticket which is transmitted from a server to the mobile device, which order ticket contains the access rights and the authorized tasks for the field device. This order ticket is transmitted when the connection is established with the field device. If authorization is available, the tasks contained in the order ticket, such as parameterization actions or execution of functional tests, can be processed with the field device.

Field devices that can be managed with such operating systems must be connected to the units to be managed (user management system in the form of a ticket server) after delivery to the customer. This usually happens through a key exchange between the field device and the managing unit, which must be carried out manually by the customer. The field device sends a join query to the unit to be managed. A user must then manually confirm the release. With a large number of field devices, this represents a personnel and cost outlay that should not be underestimated, and which can also be prone to errors, since the human error source could inadvertently classify field devices incorrectly. There is also a risk of manipulation and/or cyber attacks, such as, for example, if an attacker connects their own field devices to the network and sends a join query to obtain information about users and rights.

### SUMMARY

Based upon this problem, the object of the present disclosure is to connect field devices in a simple manner to a control system with user management.

The object is achieved by a computer-implemented process for training an AI model, wherein the processing comprises the steps of: providing training data, wherein the training data comprise input data and output data, wherein the input data comprise identification and/or function data of a plurality of field devices, and wherein the output data each comprise a result associated with the field devices as to whether or not logging into a user management system was permitted; feeding the training data to the AI model; and training the AI model using machine learning based upon the training data to identify one or more relationships between the identification and/or function data and the associated results.

The present disclosure assumes that, in the course of plant planning or design, certain structures or rules exist, so-called identification and/or function data, which are available for each of the field devices. In addition, information is already available about which field devices were allowed to be added to the user management system and which were not. These training data are used to teach or train an AI model to identify patterns or relationships as to which field devices may be added and which may not. This makes it possible to establish a reliable decision-making system.

Field devices that are mentioned in connection with the present disclosure have already been given as examples in the introductory part of the description.

A first variant of the process provides that a user manually assign a result to each of the field devices, wherein the resulting training data are fed to the AI model either collectively as a training data set or individually after the assignment has been made.

According to a second variant of the process, the training data are fed to the AI model in a collected form as at least one training data set.

In both variants, the AI model gradually identifies the relationships between the identification and/or function data through this so-called supervised learning by learning to imitate the user's decisions and thus training a classifier.

According to one embodiment, training data can also be generated by dividing the identification and/or function data into subsets, wherein a user assigns a result to each subset, wherein the training data sets each consist of one of the subsets of the identification and/or function data and the result assigned to this subset. In an embodiment of the second variant of the process, it is provided that the division of the identification and/or function data into the subsets be carried out with the help of a further AI model. This is a different AI model from the actual AI model used in the process. The further AI model works here according to so-called unsupervised learning (also called “clustering”), in which the many existing identification and/or function data are examined for similarities and/or anomalies and, based upon this, are grouped into the subsets.

According to an advantageous embodiment of the process, the AI model is based upon a neural network. In particular, it is a perceptron or “feed forward” network. Such a neural network has an input layer, an output layer, and sufficient layers (so-called “hidden layers”), each with a large number of nodes, or neurons, between the input and output layers. The input layer has one or more nodes, or neurons, for inputting the identification and/or function data. The output layer has a node, or neuron, which outputs the result as “allowed” or “not allowed.” Alternatively, an output layer can also be provided which uses a numerical output for each possibility (“allowed” or “not allowed”), which represents the probability for this value. For example, if the probability is 55% for “allowed” and 45% for “not allowed,” a closer look or examination is needed, while, if the probability is 99% or 1%, there is more confidence in the result of the model.

A neural network is also used for the further AI model.

According to one embodiment of the process, the identification and/or function data comprise one or more of the following data categories: naming of a measuring point, TAG; network address of the field device; manufacturer name; device type; serial number; and device name.

It is obvious to a person skilled in the art that further identification and/or function data relating to a field device, a measuring point, or a network of the system can also be used for the training data, in order to be able to identify a connection with a user decision. It is important to ensure that the training data contain a sufficiently large amount of such data (preferably at least 1,000 different data items per category, particularly preferably at least 10,000 different data items per category).

Furthermore, the object is achieved by using an AI model, which has been trained by means of the process according to the present disclosure, in a process for user management of field devices in automation technology, wherein the process comprises the steps of: making a user management system known in an automation system by sending invitation telegrams to at least one field device used in the system; sending a registration query of the field device to the user management system in response to the invitation telegram, which registration query contains identification and/or function data of the field device; checking the identification and/or function data by the user management system using the AI model to determine whether the field device is allowed to log on to the user management system; and registering the field device with the user management system in the case where the check produces a successful result.

This allows a reliable decision to be made as to whether a new field device may be added to the user management system or not. The process can be carried out quickly and is highly accurate.

One embodiment of the use provides that, before the step of checking the identification and/or function data by the user management system, a user first manually check with the help of the AI model whether the field device is allowed to log on to the user management system, wherein the field device is logged on to the user management system only if the check by the user and the check by the AI model each produce a successful result. The AI model is thus used to check or verify the user's manual decision regarding registration, and provides a second opinion. This can increase the security and reliability of manual decisions made by the user.

If the AI model is trusted, a field device can also be automatically registered with the user management system after its decision, without the need for human assistance.

According to one embodiment of the use, it is provided that the at least one field device and the user management system be in communications connection via a local network or via the Internet. The communications connection can be wired or wireless. In the wired variant, an Ethernet-based network can be used as a local network. Alternatively, an automation fieldbus can be used, particularly based upon one of the standards Profibus PA/DP, Foundation Fieldbus, or the like. In the case of wireless design, for example, a network based upon one of the standards WiFi, WirelessHART, ZigBee, or Bluetooth can be used.

The object is further achieved by a computer-readable medium that encodes instructions that define an AI model that has been trained by means of the process according to the present disclosure.

The object is further achieved by a computer system comprising a computer-readable medium according to the present disclosure. The computer system executes the AI model and/or trains the AI model and can thereby carry out the training process as well as the use of the trained AI model in the decision-making process. The computer system can, for example, be the user management system, which is arranged locally near the system and can communicate with the system and the field devices and/or control units located therein, such as, for example, via a LAN connection. Alternatively, the user management system is cloud-based and can be contacted via the Internet. Alternatively, the computer system that trains and/or executes the AI model is not the user management system, but a separate component.

### BRIEF DESCRIPTION OF THE DRAWINGS

The present disclosure is explained in greater detail with reference to the following figures. In the figures:

FIG. 1 shows a first exemplary embodiment of the process according to the present disclosure, in which an AI model is taught using training data; and

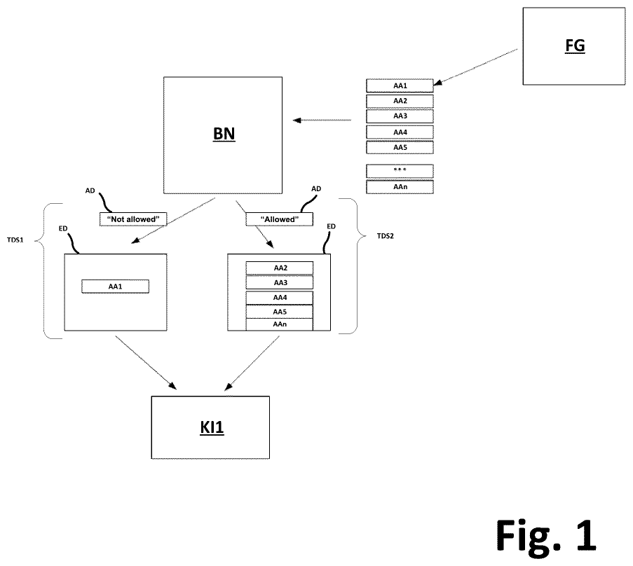

FIG. 2 shows an exemplary embodiment for generating training data.

### DETAILED DESCRIPTION

If field devices FG are to be added to a user management system, e.g., a ticket server, the user management system sends invitation telegrams via all communications connections available to the user management system. Those field devices FG which are compatible for administration via the user management system send registration queries AA1, . . . , AAn as a response telegram back to the user management system.

A user BN, e.g., an administrator of the user management system, must now check the individual registration queries AA1, . . . , AAn and decide individually whether the respective field device FG is to be added to the user management system.

The perfect and safe selection of a field device FG would be based upon the exact comparison of a key, especially an ED25519 key. However, this is not practical, because, on the one hand, these keys are not known in advance, and, on the other, they are not manageable by humans due to the large number of characters. Therefore, the user BN tries to use other information from the registration query of a field device FG.

For the specific testing of a field device FG, the user BN preferably consults the parameters from the “PostalAddress” group, which are part of the registration queries AA1, . . . , AAn. The following is an extract of the “PostalAddress” from a registration query AA1, . . . , AAn.

| PostalAddress ::= SEQUENCE { | | |
|---|---|---|
| device-id | UTF8String | OPTIONAL, |
| ip-address | UTF8String | OPTIONAL, |
| mac-address | UTF8String | OPTIONAL, |
| dns-name | UTF8String | OPTIONAL, |
| uri UTF8String | OPTIONAL, | |
| device-tag | UTF8String | OPTIONAL, |
| device-serial-number | UTF8String | OPTIONAL, |
| fieldbus-address | UTF8String | OPTIONAL |
| bluetooth-mac | UTF8String | OPTIONAL |

| | |
|---|---|
| route UTF8String | OPTIONAL |

}

This “PostalAddress” contains one or more identification and/or function data items that serve to identify the field device itself or the function in the specific system, or describe the type of communications connection of the field device FG in the system network. (Identification and/or function data contained in this example are, for example, the network address of the field device FG (=“fieldbus-address” or “ip-address,” the device name (=“device-id,” etc.), or the like. This list represents only an extract of the identification and/or function data contained in the registration queries AA1, . . . , AAn. It may be provided that the registration queries AA1, . . . , AAn contain alternative and/or additional data fields to the “PostalAddress,” which also contain identification and/or function data.

The user now begins to decide for the individual field devices FG which field devices FG are allowed to log on to the user management system and which are rejected. This means that the user BN labels this data. Specifically, the labels the data in which he assigns a result “allowed” or “not allowed” with respect to the login to the user management system. The labeled data will henceforth be called “training data.” Training data therefore contain the identification and/or function data of a field device FG as input data ED and the result or label as output data AD. After creation, these training data are gradually fed into an AI model KI1 and used to train the AI model KI1. The training data can also be collected as training data sets TD1, TD2 and fed to the AI model KI1.

The AI model KI1 is based in particular upon a neural network. In particular, it is a perceptron or “feed forward” network. Such a neural network has an input layer, an output layer, and sufficient layers (so-called “hidden layers”), each with a large number of nodes, or neurons, between the input and output layers. The input layer has one or more nodes, or neurons, for inputting the identification and/or function data. The output layer has a node, or neuron, which outputs the result as “allowed” or “not allowed.”

The AI model KI1 can be trained using the training data. In the course of so-called machine learning, the AI model KI1 learns patterns that are relevant for the decision. The AI model KI1 learns relationships between the input data ED (the identification and/or function data) and the associated output data AD (the results of the evaluation of the user BN).

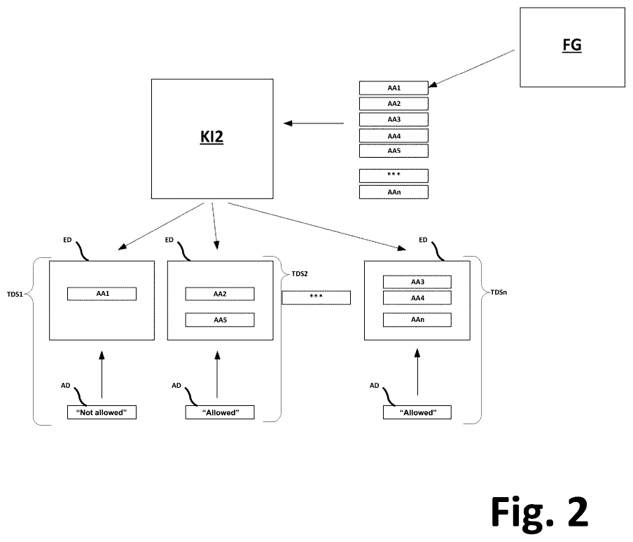

FIG. 2 describes another example of how the training data sets TDS1, . . . , TDSn, which are fed to the AI model KI1 for training, are created. In this example, a large number of registration queries AA1, . . . , AAn from a large number of field devices FG have already arrived at the user management system after the system has been put into operation. Another AI model KI2, which works on cluster detection/pattern recognition, analyzes these registration queries AA1, . . . , AAn and begins to cluster them. This involves a division into several (abstract) clusters or groups. For example, certain entries of the identification and/or function data of all registration queries AA1, . . . , AAn in a group are similar.

The user BN then actively labels each of these groups with the result “allowed” or “not allowed.” Thus, a training data set TDS1, . . . , TDSn is created from each group.

In the further course, all field devices FG whose registration query AA1, . . . , AAn is in a group with the result “allowed” can be admitted to the user management system. Furthermore, the individual training data sets TDS1, . . . , TDSn are passed on to the AI model KI1 for training.

The trained AI model KI1 can then apply what it has learned and support or replace the user in making decisions about new field devices. To do this, the AI model examines a registration query AA1, . . . , AAn of a new field device FG.

“Supporting” the user BN means that the AI model creates a second opinion in addition to the manual decision of the user BN. The manual decision of the user BN can thus be confirmed or refuted by the AI model KI1.

“Replacing” the user BN means that the AI model has sole decision-making power to allow or deny a field device FG to log in to the user management system. The registration process can thereby also be carried out automatically.

The present disclosure promises the advantage that time can be saved when registering field devices FG with a user management system, while at the same time increasing the reliability of the decision quality compared to a human user BN as the deciding authority.

1. A computer-implemented process for training an AI model, comprising:
providing training data, wherein the training data comprise input data and output data, wherein the input data comprise identification and/or function data of a plurality of field devices, and wherein the output data each comprise a result associated with the field devices as to whether or not logging into a user management system was permitted;
feeding the training data to the AI model; and
training the AI model using machine learning based upon the training data to identify one or more relationships between the identification and/or function data and the associated results.

2. The process according to claim 1, wherein a user manually assigns a result to each of the field devices, wherein the resulting training data are fed individually to the AI model after the assignment has taken place.

3. The process according to claim 1, wherein the training data are fed to the AI model collected as at least one training data set.

4. The process according to claim 3, wherein the identification and/or function data are divided into subsets, wherein a user assigns a result to each subset, wherein the training data set or the training data sets each consist of one of the subsets of the identification and/or function data and the result assigned to this subset.

5. The process according to claim 4, wherein the division of the identification and/or function data into the subsets is carried out with the aid of a further AI model.

6. The process according to claim 1, wherein the AI model is based upon a neural network.

7. The process according to claim 1, wherein the identification and/or function data comprise one or more of the following data categories:
naming of a measuring point;
network address of the field device;
manufacturer name;
device type;
serial number;
device name.

8. A use of an AI model which has been trained by means of a process, wherein the process includes providing training data, wherein the training data comprise input data and output data, wherein the input data comprise identification and/or function data of a plurality of field devices, and wherein the output data each comprise a result associated with the field devices as to whether or not logging into a user management system was permitted; feeding the training data to the AI model; and training the AI model using machine learning based upon the training data to identify one or more relationships between the identification and/or function data and the associated results, wherein the process comprises the steps of:
making a user management system known in an automation system by sending invitation telegrams to at least one field device used in the system;
sending a registration query of the field device to the user management system in response to the invitation telegram, which registration query contains identification and/or function data of the field device;
checking the identification and/or function data by the user management system using the AI model to determine whether the field device is allowed to log on to the user management system; and
registering the field device with the user management system in the case where the check produces a successful result.

9. The use according to claim 8, wherein, before the step of checking the identification and/or function data by the user management system, a user first manually checks with the help of the AI model whether the field device is allowed to log on to the user management system, wherein the field device is only logged on to the user management system if the check by the user and the check by the AI model each produce a successful result.

10. The use according to claim 8, wherein the at least one field device and the user management system are in communications connection via a local network or via the Internet.

11. The use according to claim 10, wherein the communications connection is wired or wireless.

12. A computer-readable medium encoding instructions defining an AI model trained by a process, wherein the process includes: providing training data, wherein the training data comprise input data and output data, wherein the input data comprise identification and/or function data of a plurality of field devices, and wherein the output data each comprise a result associated with the field devices as to whether or not logging into a user management system was permitted; feeding the training data to the AI model; and training the AI model using machine learning based upon the training data to identify one or more relationships between the identification and/or function data and the associated results.
